(19) United States
(12) Patent Application Publication
(10) Pub. No.: US 2026/0082167 A1
(43) Pub. Date: Mar. 19, 2026

(54) SPEAKER

(71) Applicant: ALPS ALPINE CO., LTD., Tokyo (JP)

(72) Inventor: Haruki UESUGI, Fukushima (JP)

(21) Appl. No.: 19/283,894

(22) Filed: Jul. 29, 2025

(30) Foreign Application Priority Data
Sep. 18, 2024 (JP) 2024-160766

(51) Int. Cl. H04R 29/00; H04R 9/02; H04R 9/06

(52) U.S. Cl. CPC H04R 29/003; H04R 9/025; H04R 9/06; H04R 2209/022

(57) ABSTRACT

A speaker includes: a drive-and-support part having a frame; a vibrating part supported by the frame such that the vibrating part is able to vibrate; a magnetic drive part configured to make the vibrating part vibrate; a detection magnet provided in one of the drive-and-support part or the vibrating part; a first magnetic sensor and a second magnetic sensor provided in the other one of the drive-and-support part or the vibrating part, and configured to detect a magnetic field produced by the detection magnet; and a detection circuit configured to determine a difference between a first detection output of the first magnetic sensor and a second detection output of the second magnetic sensor. The first and second magnetic sensors are spaced apart from each other in a direction in which the vibrating part vibrates.

### CROSS-REFERENCE TO RELATED APPLICATIONS

This application is based on and claims priority to Japanese Patent Application No. 2024-160766, filed on Sep. 18, 2024, the entire content of which is incorporated herein by reference.

### BACKGROUND OF THE INVENTION

### 1. Field of the Invention

The present disclosure relates to a speaker that can detect the movement of a vibrating part including a vibrating plate, with a high degree of accuracy, by using a magnetic sensor.

### 2. Description of the Related Art

An existing speaker of an audio device only receives and processes audio signals output from an amplifier, producing sound pressures, and does not control its own operation depending on audio signals. Consequently, sound is often produced with distortion, with a quality that is prone to variation. Furthermore, when the amplitude of the vibrating plate becomes too high, the vibrating plate as well as the damper (shock absorber) get damaged.

To solve the above-described problems, patent document 1 discloses a speaker that detects the movement of a vibrating plate using a magnetic sensor and execute feedback control. In this speaker, a magnetic sensor such as a giant magneto resistive (GMR) element is fixed onto a top plate, and a small second magnet is attached to an outer surface of a bobbin around which a voice coil is wound. A first magnet is provided to impart magnetic flux to the voice coil in a gap, and the magnetic sensor can detect the orientation of the composite magnetic flux combining the magnetic flux of the first magnet and the magnetic flux of the second magnet, in a plane that is perpendicular to the direction in which the voice coil vibrates.

FIG. 3 of patent document 1 shows the displacement of the voice coil depending on the voltage applied to the voice coil. The dashed line in the figure shows how the distortion of sound due to applied voltage is corrected by executing feedback control using adaptive signal processing based on the orientation of the composite magnetic flux detected by the magnetic sensor.

### CITATION LIST

### Patent Document

Patent Document 1: Unexamined Japanese Patent Application Publication No. 2022-149259

### SUMMARY OF THE INVENTION

### Problem to be Solved by the Invention

The speaker disclosed in patent document 1 can only execute feedback control as shown in FIG. 3 of patent document 1, that is, only when the second magnet is moving above the magnetic sensor, as shown in FIG. 1 of patent document 1. This is because, even if the second magnet successfully moves from above to below the magnetic sensor, the orientation of the magnetic field of the first magnet and the orientation of the magnetic field of the second magnet stay the same, and the composite magnetic flux detected by the magnetic sensor changes only in the same direction (that is, its orientation does not change). As a result of this, it is not possible to distinguish whether the second magnet is located above or below the magnetic sensor.

With the speaker disclosed in patent document 1, the second magnet can move only in the space above the magnetic sensor. When the second magnet moves to a distant position above the magnetic sensor, the amount of magnetism that comes from the second magnet and that can be detected by the magnetic sensor decreases, making it difficult for the magnetic sensor to produce reliable detection outputs. Consequently, the range of vibrations in which feedback control can be performed with a high degree of accuracy is limited. Measures may be taken so as to enable the second magnet to emit a greater amount of magnetism, but, provided that the second magnet is made from rare earth metals, such measures might entail an increase in the cost of the second magnet.

The present disclosure therefore aims to solve the above-described problems with existing art by providing a speaker that has two magnetic sensors for detecting the magnetic field from a detection magnet, determines the difference between respective detection outputs of the two magnetic sensors, and thereby expands the range of vibrations that can be detected with a high degree of accuracy.

### Means for Solving the Problem

According to the present disclosure, a speaker includes: a drive-and-support part having a frame; a vibrating part supported by the frame such that the vibrating part is able to vibrate; a magnetic drive part configured to make the vibrating part vibrate; a detection magnet provided in one of the drive-and-support part or the vibrating part; a first magnetic sensor and a second magnetic sensor provided in the other one of the drive-and-support part or the vibrating part, and configured to detect a magnetic field produced by the detection magnet; and a detection circuit configured to determine a difference between a first detection output of the first magnetic sensor and a second detection output of the second magnetic sensor. The first and second magnetic sensors are spaced apart from each other in a direction in which the vibrating part vibrates.

According to the present disclosure, in the speaker described above:
the first and second magnetic sensors are fixed to the drive-and-support part; and
the detection magnet is provided in the vibrating part.

According to the present disclosure, in the speaker described above:
the first and second magnetic sensors are provided in the drive-and-support part;
the detection magnet is provided in the vibrating part;
for each of the first and second magnetic sensors, an orientation of a first magnetic field imparted from a fixed magnet that is fixed to the drive-and-support part, and an orientation of a second magnetic field imparted from the detection magnet, intersect with each other; and
each of the first and second magnetic sensors detects changes in intensities of the first and second magnetic fields.

According to the present disclosure, in the speaker described above, each of the first and second magnetic sensors detects a change in an orientation of a composite vector obtained by combining the first and second magnetic fields from the two directions.

According to the present disclosure, in the speaker described above:
a magnetic circuit part that constitutes the magnetic drive part is provided in the drive-and-support part;
a voice coil is provided in the vibrating part;
the fixed magnet is a part of the magnetic circuit part; and
the first magnetic field from the fixed magnet travels across the voice coil.

According to the present disclosure, in the speaker described above:
the vibrating part is in a neutral position when the magnetic drive part is not at work; and
when the vibrating part is in the neutral position, the detection circuit determines that the difference between the first detection output of the first magnetic sensor and the second detection output of the second magnetic sensor is zero.

According to the present disclosure, in the speaker described above, when the vibrating part is in the neutral position, the detection magnet and one of the first magnetic sensor or the second magnetic sensor are positioned side by side in a direction that is perpendicular to the direction in which the vibrating part vibrates.

### Advantageous Effects of the Invention

In accordance with the above description of the speaker of the present disclosure, the speaker determines the difference between the first and second magnetic sensors' respective detection outputs, and detects the position of the vibrating part based on that difference. Consequently, when the vibrating part moves in one of the directions in which the detection magnet vibrates and when the detection magnet moves in the other direction, relative to the origin, the detection magnet can provide detection outputs with different signs, so that the range in which the vibrating part can be detected can be expanded. Allowing the range in which the vibrating part can be detected to be expanded makes it possible to detect the position of the vibrating part with a high degree of accuracy.

### BRIEF DESCRIPTION OF THE DRAWINGS

FIG. 1 is a half-cross-sectional view showing half of a longitudinal cross-section of a speaker according to an embodiment of the present disclosure;

FIG. 2 is a partially enlarged perspective view showing two magnetic sensors, a detection magnet, and a part of a magnetic circuit part provided in a speaker according to an embodiment of the present disclosure;

FIG. 3 is an enlarged view for explaining a spin valve GMR element as an example of a magnetic sensor;

FIG. 4 is an enlarged view for explaining an example using a pair of detection elements as another example of a magnetic sensor;

FIG. 5 is a side view showing an example of relative positioning of two magnetic sensors and a detection magnet;

FIG. 6A is a diagram showing an example of how two magnetic sensors' detection outputs change;

FIG. 6B is a diagram showing an example of how two magnetic sensors' detection outputs differ from each other;

FIG. 7 is a diagram showing another example of how two magnetic sensors' detection outputs change;

FIG. 8 is a side view showing a modification of two magnetic sensors;

FIG. 9 is a circuit block diagram showing a structure of a detection circuit provided in a speaker according to an embodiment of the present disclosure; and

FIG. 10 is a side view showing a comparative example using one magnetic sensor.

### DETAILED DESCRIPTION OF THE DISCLOSURE

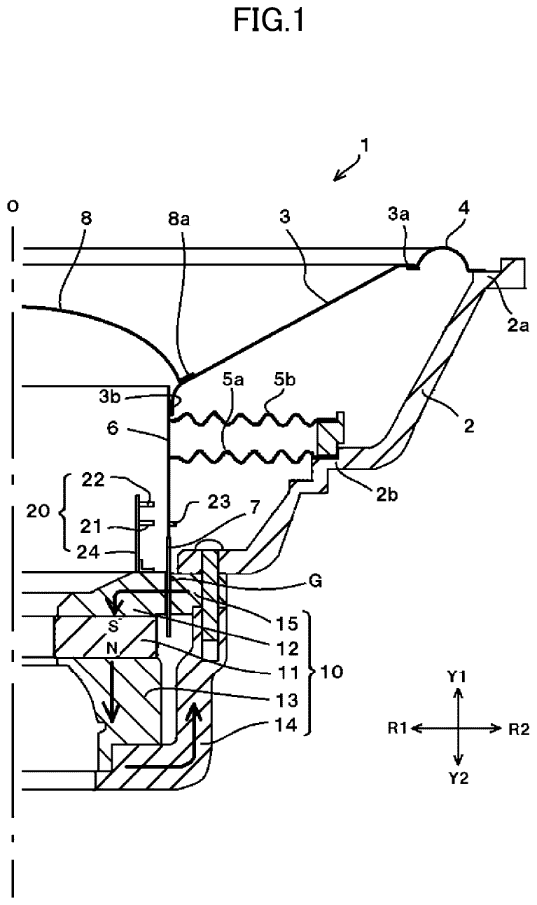

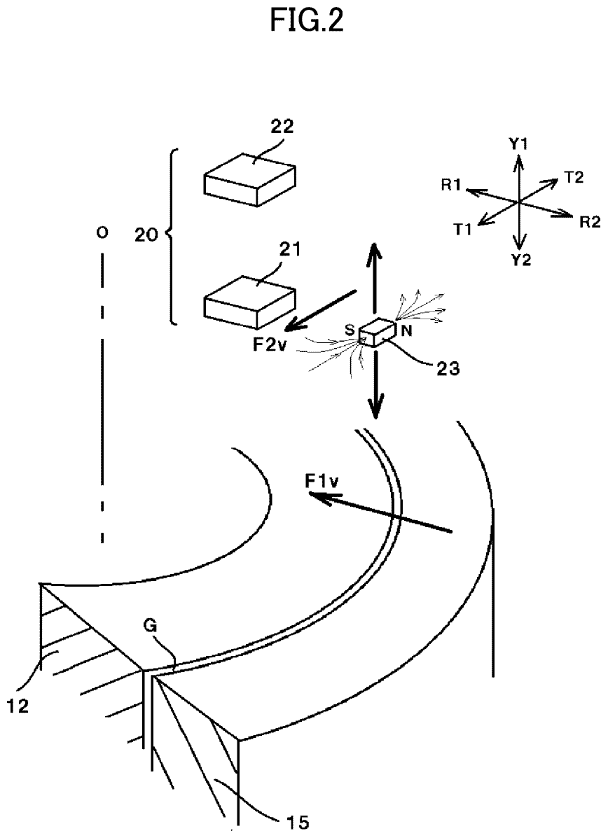

Referring to FIG. 1, where a speaker 1 according to an embodiment of the present disclosure is provided, the direction indicated by the arrow labeled “Y1” and the direction indicated by the arrow labeled “Y2” will be hereinafter collectively referred to as the “Y1-Y2 direction” or the “front-rear direction.” That is, the Y1 direction is the front direction, and the Y2 direction is the rear direction. The direction in which the speaker 1 produces sound varies depending on the mode of use. The speaker 1 may be used in a way in which sound is produced in the Y1 direction or in a way in which sound is produced in the Y2 direction. FIG. 1 shows a center axis O, which extends in the front-rear direction (the Y1-Y2 direction). The main part of the speaker 1 is a structure that is substantially rotationally symmetric about the center axis O. The directions indicated by the arrows labeled “R1” and “R2” are radial directions and will be hereinafter collectively referred to as the “R1-R2 direction.” That is, the R1 direction extends toward the center (the center axis O), and the R2 direction extends outward. Furthermore, the directions indicated by the arrows labeled “T1” and “T2” in subsequent drawings are tangential directions and will be hereinafter collectively referred to as the “T1-T2 direction.” As shown in FIG. 2, the R1-R2 direction and the T1-T2 direction are orthogonal to each other in a plane that is perpendicular to the center axis O.

The speaker 1 shown in FIG. 1 has a frame 2. The frame 2 is a non-magnetic member or a magnetic member, and has a tapered shape in which the diameter of the frame 2 expands gradually toward the front (in the Y1 direction). A magnetic circuit part 10 is fixed behind (in the Y2 direction with respect to) the frame 2 by adhesive or screw fastening. The frame 2 and the magnetic circuit part 10 together constitute a “drive-and-support part.”

The magnetic circuit part 10 includes: a fixed magnet 11 that is annular in shape around the center axis O; an annular top plate 12 joined to a front part of the fixed magnet 11; a rear yoke 13 joined to a rear part of the fixed magnet 11; an outer yoke 14 joined to the rear yoke 13; and an opposite yoke 15 that is annular in shape and joined to a front part of the outer yoke 14. The top plate 12, the rear yoke 13, the outer yoke 14, and the opposite yoke 15 are magnetic members, that is, magnetic metal members.

A magnetic gap G is formed between the outer surface of the top plate 12 and the inner surface of the opposite yoke 15. The magnetic gap G runs circumferentially around the center axis O. In the magnetic circuit part 10, a drive magnetic flux F1 is emitted from the fixed magnet 11. Starting off from the rear yoke 13, the drive magnetic flux F1 passes the outer yoke 14 and the opposite yoke 15, travels across the magnetic gap G, and reaches the top plate 12. The drive magnetic flux F1 may travel in the opposite direction to the circular path shown in FIG. 1. In the space in front of the magnetic circuit part 10, magnetic flux leaks from the drive magnetic flux F1 circulating inside the magnetic circuit part 10. In FIG. 2, the fixed magnetic field vector labeled “F1v” indicates the orientation and magnitude of the component having the strongest magnetic field in the magnetic flux leaking from the drive magnetic flux F1, in a plane perpendicular to the center axis O and in the same longitudinal cross section as in FIG. 1. In the examples of FIG. 1 and FIG. 2, the fixed magnetic field vector F1v points in the R1 direction.

As shown in FIG. 1, a vibrating plate 3 is provided inside the front part of the frame 2. The vibrating plate 3 has a cone shape. The frontmost circumferential part 2a of the frame 2 and the outer circumferential edge 3a of the vibrating plate 3 are joined together by an elastically deformable edge member 4. The edge member 4 and the frontmost circumferential part 2a, as well as the edge member 4 and the outer circumferential edge 3a, are fixed by an adhesive. An inner circumferential fixed part 2b is formed in an inner surface of a middle part of the frame 2. A damper member 5a and a damper member 5b, having a corrugated cross section and being elastically deformable, namely, their respective outer circumferential parts, are fixed to the inner circumferential fixed part 2b of the frame 2 by an adhesive.

A bobbin 6 is provided inside the frame 2. The bobbin 6 has a cylindrical shape centered about the center axis O. An inner circumferential edge 3b of the vibrating plate 3 is fixed to an outer surface of the bobbin 6 by an adhesive. The inner circumferential parts of the damper members 5a and 5b are also fixed to the outer surface of the bobbin 6 by an adhesive. A dome-shaped cap 8 that protrudes forward (in the Y1 direction) is provided at the center of the vibrating plate 3. The cap 8 covers the front opening of the bobbin 6, and a peripheral part 8a of the cap 8 is fixed to a front surface of the vibrating plate 3 by an adhesive.

A voice coil 7 is provided on an outer surface of the rear-end part of the bobbin 6 facing backward (the Y2 direction). The voice coil 7 is a predetermined number of turns of a coated conductor wire wound on the outer surface of the bobbin 6. The voice coil 7 is located inside the magnetic gap G of the magnetic circuit part 10. The magnetic circuit part 10 and the voice coil 7 constitute the “magnetic drive part.”

Given the elastic deformation of an edge member 4 and the damper members 5a and 5b, the vibrating plate 3 and the bobbin 6 are supported such that they can vibrate back and forth (that is, in the Y1-Y2 direction) with respect to the frame 2 (or the drive-and-support part). The vibrating plate 3, the cap 8, the bobbin 6, and the voice coil 7 constitute a “vibrating part” that vibrates back and forth (in the Y1-Y2 direction) with respect to the “drive-and-support part” including the frame 2.

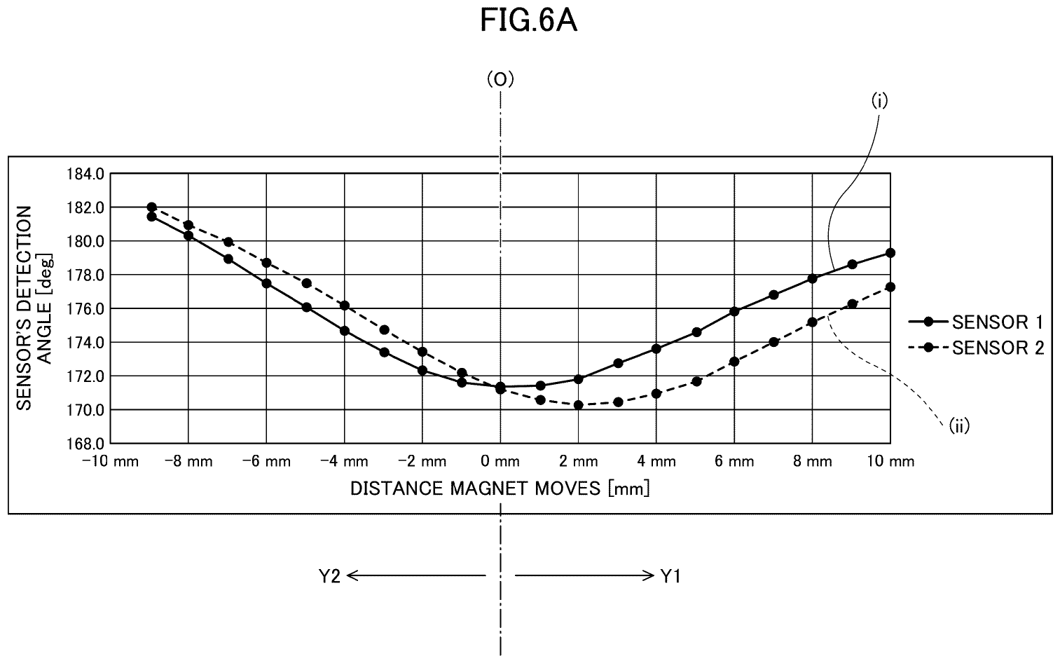

As shown in FIG. 1 a detection part 20 (vibration detection part) is provided in the speaker 1. The detection part 20 detects the vibration of the vibrating part including the vibrating plate 3, the bobbin 6, and the voice coil 7. As shown in FIG. 5, a first magnetic sensor 21 and a second magnetic sensor 22 provided in the drive-and-support part; and a detection magnet (movable magnet) 23 provided in the vibrating part together constitute the detection part 20. A sensor support member 24 is fixed to the front surface of the top plate 12 that constitutes the magnetic circuit part 10. The first magnetic sensor 21 and the second magnetic sensor 22 are supported by the sensor support member 24.

FIG. 1 is a cross-sectional view of the speaker 1, cut in a longitudinal cross section parallel to a Y-R plane and including the center axis O. It is preferable if the center of the first magnetic sensor 21 and the second magnetic sensor 22 and the center of the detection magnet 23 are located in the same longitudinal cross section. As shown in FIG. 1 and FIG. 2, the first magnetic sensor 21 and the second magnetic sensor 22 are spaced apart from each other in the front-rear direction (the Y1-Y2 direction) in which the vibrating part vibrates. Since the sensor support member 24 is positioned inward of the bobbin 6, the detection magnet 23 moves back and forth, as the vibrating part vibrates, in positions facing the first magnetic sensor 21 and the second magnetic sensor 22 from outside (that is, from the R2 side). It is also possible to employ a structure in which the sensor support member 24 is positioned outward of the bobbin 6, and the detection magnet 23 moves back and forth in positions facing the first magnetic sensor 21 and the second magnetic sensor 22 from inside (that is, from the R1 side).

As shown in FIG. 2, the detection magnet 23 is magnetized in tangential directions (the T1-T2 direction), and there is magnetic flux leaking from the detection magnet 23 in the space where the first magnetic sensor 21 and the second magnetic sensor 22 are provided. In FIG. 2, the movable magnetic field vector labeled “F2v” indicates the orientation and magnitude of the component having the strongest magnetic field in the magnetic flux leaking from the detection magnet 23 in a plane perpendicular to the center axis O. In the example of FIG. 2, the movable magnetic field vector F2v points in the T1 direction.

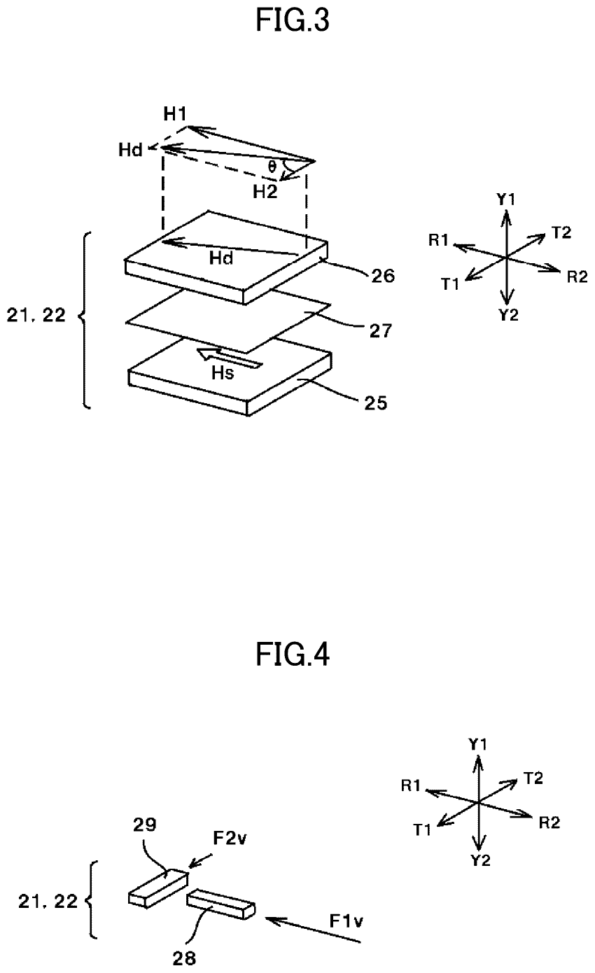

The first magnetic sensor 21 and the second magnetic sensor 22 can detect changes in the orientation of the acting magnetic field, in a plane that is perpendicular to the center axis O and that passes the center of the magnetic sensors 21 and 22 (a plane that is parallel to the R-T plane). As shown in FIG. 2, the fixed magnetic field vector F1v, which is magnetic flux leaking from the drive magnetic flux F1 of the fixed magnet 11, is oriented in a radial direction (the R1 direction) with respect to the magnetic sensors 21 and 22. The movable magnetic field vector F2v, which is magnetic flux leaking from the detection magnet 23, is oriented in a tangential direction (the T1 direction) with respect to the magnetic sensors 21 and 22. As shown in FIG. 3, the magnetic sensors 21 and 22 detect changes in the orientation of a detection magnetic field Hd, which is a vector combining the magnetic field H1 originating from the fixed magnetic field vector F1v and the magnetic field H2 originating from the movable magnetic field vector F2v together. Since the relative positions of the magnetic sensors 21 and 22 and the fixed magnet 11 do not change, the intensity of the magnetic field H1 acting on the magnetic sensors 21 and 22 stays practically unchanged. By contrast with this, the distance between the detection magnet 23 and the magnetic sensors 21 and 22 changes when the vibrating part vibrates back and forth (that is, in the Y1-Y2 direction), and so the intensity of the magnetic field H2 detected by the magnetic sensors 21 and 22 also changes. It then follows that the orientation θ of the detection magnetic field Hd (to be more specific, its angle with respect to the tangential direction in a plane perpendicular to the center axis O), which is a composite vector, changes as the vibrating part vibrates back and forth.

The magnetic sensors 21 and 22 each have at least one magneto resistive (MR) element. The MR element is a spin-valve GMR element or a tunnel magneto resistive (TMR) element. FIG. 3 shows a schematic structure of a GMR element. The GMR element is structured such that a fixed magnetic layer 25 and a free magnetic layer 26 are laminated with a non-magnetic conductive layer 27 sandwiched between them. Whereas the orientation of the fixed magnetization Hs of the fixed magnetic layer 25 is biased and fixed, the orientation of the magnetic field of the free magnetic layer 26 follows the changes of the detection magnetic field Hd's orientation. The electrical resistance value of the spin-valve GMR element changes depending upon changes of the relative angle formed between the orientation of the fixed magnetization Hs of the fixed magnetic layer 25 and the orientation of the detection magnetization Hd of the free magnetic layer 26. Based on this changing electrical resistance value, accordingly, changes in the angle θ of the vector of the detection magnetic field Hd can be detected.

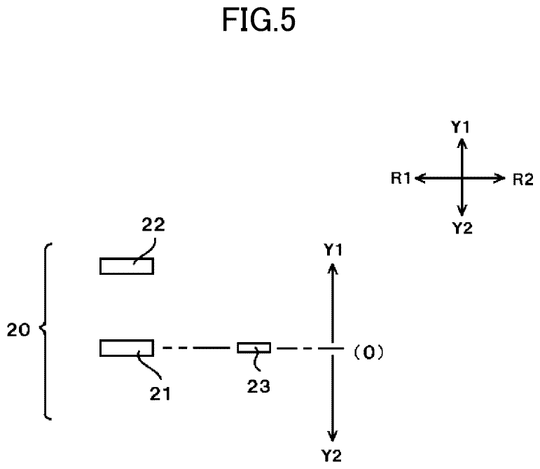

Referring now to FIG. 4, which shows another example structure of the first magnetic sensor 21 and the second magnetic sensor 22, one magnetic sensor may include: a magnetic detection element 28 that detects only the intensity of the magnetic field that acts radially (that is, in the R1 direction); and a magnetic detection element 29 that detects only the intensity of the magnetic field that acts tangentially (that is, in the T1 direction). This magnetic sensor detects changes in the intensity of the magnetic field of the movable magnetic field vector F2v detected by the magnetic detection element 29, based on the intensity of the magnetic field of the fixed magnetic field vector F1v detected by the magnetic detection element 28, thereby obtaining detection outputs that are equivalent to those obtained when detecting changes in the orientation of the detection magnetic field Hd's vector. Hall elements or anisotropic magneto resistive (AMR) elements can be used as the magnetic detection elements 28 and 29.

As for the structure of the detection part 20, a fixed magnet other than the fixed magnet 11 that constitutes the magnetic circuit part 10 may be provided, and a fixed magnetic field vector that originates from this fixed magnet may be detected by the magnetic sensors 21 and 22.

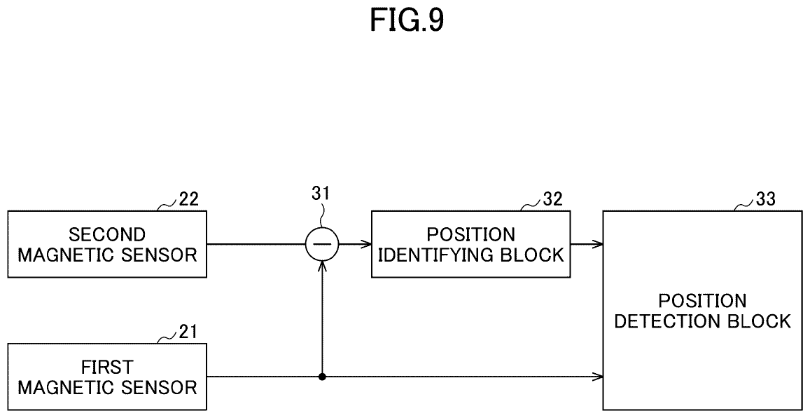

FIG. 9 shows a detection circuit 30 attached to the speaker 1. The detection circuit 30 is mounted on a substrate that is fixed to the frame 2 of the speaker 1, or on a substrate spaced apart from the frame 2. A CPU, a memory, etc. together constitute the detection circuit 30. The CPU executes processes based on the block diagram of FIG. 9 by firmware. A subtraction part 31 is provided in the detection circuit 30, and determines the difference between the detection output of the first magnetic sensor 21 and the detection output of the second magnetic sensor 22. In the example shown in FIG. 9, the detection output of the first magnetic sensor 21 is subtracted from the detection output of the second magnetic sensor 22. However, the subtraction part 31 may also subtract the detection output of the second magnetic sensor 22 from the detection output of the first magnetic sensor 21. Based on the positive or negative sign of the difference determined by the subtraction “the detection output from the second magnetic sensor 22−the detection output from the first magnetic sensor 21,” the position identifying block 32 decides whether the detection magnet 23 is located in front of or behind the first magnetic sensor 21 (whether the detection magnet 23 is located in the Y1 direction or in the Y2 direction with respect to the first magnetic sensor 21). The position detection block 33 detects the position of the detection magnet 23 in the front-rear direction (the Y1-Y2 direction) from the value decided in the position identifying block 32 and the detection output of the first magnetic sensor 21.

Next, how the speaker 1 operates to produce sound will be described. In the operation for producing sound, a drive current is supplied to the voice coil 7 based on an audio signal output from an audio amplifier. The drive magnetic flux F1 emitted from the fixed magnet 11 in the magnetic circuit part 10 travels across the voice coil 7 in the magnetic gap G. The electromagnetic force excited by the drive magnetic flux F1 and the drive current causes the vibrating part including the bobbin 6 and the vibrating plate 3 to vibrate back and forth (in the Y1-Y2 direction), generating a sound pressure that matches the frequency of the drive current and emitting toward the front or rear.

When the vibrating part vibrates and causes the detection magnet 23 to move back and forth, the detection part 20 determines the difference between the detection output of the second magnetic sensor 22 and the detection output of the first magnetic sensor 21, and detects the position of the detection magnet 23 with a high degree of accuracy. A control part is provided next to or near the speaker 1, and executes feedback control based on detection outputs from the detection circuit 30. For example, the control part calculates the magnitude of deviation between: the vibrating part's ideal position and its changes in the front-rear direction (the Y1-Y2 direction) anticipated from the audio signal applied; and the vibrating part's actual position and its changes determined by the detection circuit 30. If the magnitude of deviation exceeds a threshold, an offset signal is generated to improve the magnitude of deviation. The offset signal is superimposed on the drive signal (voice current) supplied to the voice coil 7, and, by means of this feedback control, the distortion and deviation of sound as emitted from the speaker 1 are improved, and, furthermore, the vibrating plate 3 is prevented or substantially prevented from vibrating back and forth excessively.

The detection operation of the detection part 20 and the detection circuit 30 will be described below in detail. When no current is applied to the voice coil 7 and the vibrating part including the vibrating plate 3 and the bobbin 6 is in a neutral position in the front-rear direction (the Y1-Y2 direction), it is preferable to position the detection magnet 23 and one of the first magnetic sensor 21 and the second magnetic sensor 22 radially side by side (side by side in the R1-R2 direction) that is perpendicular to the center axis O. As shown in FIG. 1 and FIG. 5, in the speaker 1 of the embodiment, when the vibrating part is in a neutral position, the first magnetic sensor 21 and the detection magnet 23 are positioned radially side by side (side by side in the R1-R2 direction), and the center of the first magnetic sensor 21 and the center of the detection magnet 23 are in the same position in the front-rear direction (the Y1-Y2 direction).

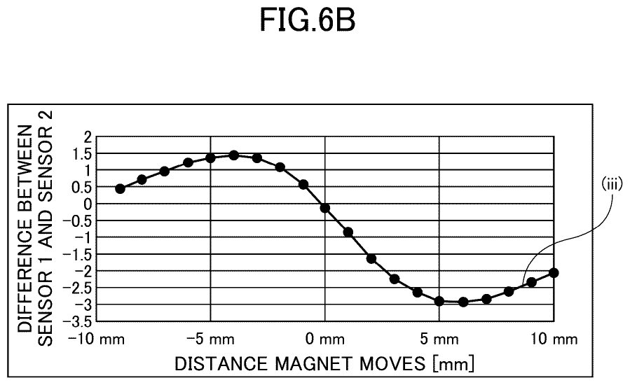

FIG. 6A shows the detection output of the first magnetic sensor 21 and the detection output of the second magnetic sensor 22. In FIG. 6A, the horizontal axis is the position of the detection magnet 23 in the front-rear direction (the Y1-Y2 direction). As shown in FIG. 5, when the first magnetic sensor 21 and the detection magnet 23 are positioned radially side by side (side by side in the R1-R2 direction), the detection magnet 23 is positioned at the origin (0). The vertical axis in FIG. 6A indicates both the detection output of the first magnetic sensor 21 and the detection output of the second magnetic sensor 22. These detection outputs change following changes of the orientation θ of the detection magnetic field Hd shown in FIG. 3. Since the magnetic field H1 acting on the magnetic sensors 21 and 22 originates from the magnetic flux produced from the fixed magnet 11, the intensity of the magnetic field H1 detected by the first magnetic sensor 21 and the second magnetic sensor 22 stays practically unchanged. By contrast with this, the magnetic field H2 detected by the first magnetic sensor 21 and the second magnetic sensor 22 increases as the distance between each magnetic sensor and the detection magnet becomes shorter. Thus, the orientation (angle) θ of the detection magnetic field Hd, which is a composite vector, becomes smaller as the distance between each magnetic sensor and the detection magnet becomes shorter. In the GMR element, the direction of magnetization of the free magnetic layer 26 changes depending on the orientation of the detection magnetic field Hd. The electrical resistance value of the GMR element decreases as the fixed magnetization Hs of the fixed magnetic layer 25 and the magnetization of the free magnetic layer 26 get closer to being parallel.

In FIG. 6A, the solid dotted line labeled “(i)” shows how the detection output of the first magnetic sensor 21 changes, and the dashed dotted line labeled “(ii)” shows how the detection output of the second magnetic sensor 22 changes. The angle θ of the detection magnetic field Hd acting on the first magnetic sensor 21 has the minimum value when the detection magnet 23 is at the origin (0) as shown in FIG. 5. At this time, the electrical resistance value of the first magnetic sensor 21, which is a GMR element, has the maximum value. Because the second magnetic sensor 22 is located in front of (in the Y1 direction with respect to) the first magnetic sensor 21, when the angle θ of the detection magnetic field Hd acting on the second magnetic sensor 22 is the minimum value and the electrical resistance value is the maximum value, the detection magnet 23 is offset forward (in the Y1 direction) from the position where the angle θ in the first magnetic sensor 21 becomes the minimum value. In the example shown in FIG. 6A, the distance between the first magnetic sensor 21 and the second magnetic sensor 22 in the front-rear direction (the Y1-Y2 direction) is 2 millimeters (mm).

The dotted line labeled “(iii)” in FIG. 6B shows the resultant value of the subtraction “the detection output from the second magnetic sensor 22−the detection output from the first magnetic sensor 21,” which is calculated by the subtraction part 31 of the detection circuit 30 shown in FIG. 9. Referring to FIG. 6A, when the detection magnet 23 is in a neutral position (0), the detection output of the first magnetic sensor 21 and the detection output of the second magnetic sensor 22 have the same value, that is, the difference between the two detection outputs is zero. Therefore, as shown in FIG. 6B, when the detection magnet 23 is at the origin (0), the difference value of the line (iii) is zero. When the detection magnet 23 moves forward (in the Y1 direction) from the origin (0), the sign of the difference value of the line (iii) is negative. When the detection magnet 23 moves backward (in the Y2 direction) from the origin (0), the sign of the difference value of the line (iii) is positive.

In the detection circuit 30 shown in FIG. 9, the position identifying block 32 determines whether the detection magnet 23 is located in front of or behind the origin (0) (whether the detection magnet 23 is located in the Y1 direction or in the Y2 direction with respect to the origin (0)) based on the sign of the difference value of the line (iii). In the position detection block 33, based on the information determined in the position identifying block 32, how the detection output of the first magnetic sensor 21 shown by the line (i) changes is monitored. Referring to FIG. 6A, the line (i), which shows how the detection output of the first magnetic sensor 21 changes, alone does not suffice to distinguish whether the detection magnet 23 is located in front of or behind the origin (0) (whether the detection magnet 23 is located in the Y1 direction or in the Y2 direction with respect to the origin (0)). However, the information determined in the position identifying block 32 allows this decision to be made, so that the position detection block 33 can accurately identify the position of the detection magnet 23.

The detection circuit 30 shown in FIG. 9 can detect the position of the detection magnet 23 over a wide range spanning forward and backward (in the Y1-Y2 direction) from the origin (0), so that the detection magnet 23 can be detected over a wide range of amplitudes of the vibrating part including the vibrating plate 3. Also, since the detection magnet 23 does not get too far from the magnetic sensors 21 and 22, the vibration of the vibrating part can be detected with high sensitivity. Because the first magnetic sensor 21 and the second magnetic sensor 22 produce differing outputs insofar as they are separated in the front-rear direction (the Y1-Y2 direction), the distance between the first magnetic sensor 21 and the second magnetic sensor 22 in the front-rear direction (the Y1-Y2 direction) need not be made unnecessarily long. For example, as shown in FIG. 6A, the distance between the first magnetic sensor 21 and the second magnetic sensor 22 in the front-rear direction (the Y1-Y2 direction) may be approximately 2 mm. Therefore, there is no need to secure, inside the speaker 1, a wide space in the front-rear direction (the Y1-Y2 direction) for placing the first magnetic sensor 21 and the second magnetic sensor 22.

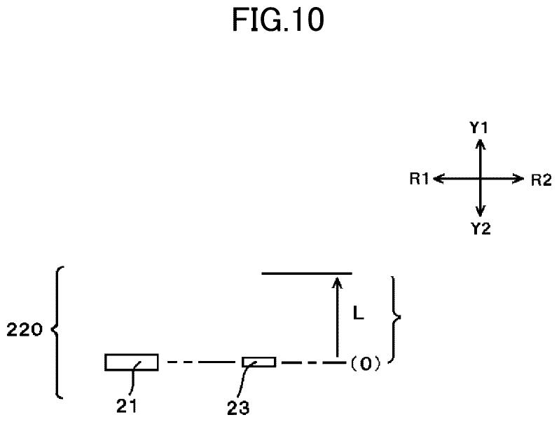

FIG. 10 shows a detection part 220 according to a comparative example. In the detection part 220 of the comparative example, one magnetic sensor 21 is provided in the drive-and-support part, and the detection magnet 23 is attached to the bobbin of the vibrating part. The magnetic sensor 21 includes a spin-valve GMR element. Detection by one magnetic sensor 21 does not suffice when deciding whether the detection magnet 23 is located in front of or behind the origin (0) (whether the detection magnet 23 is located in the Y1 direction or in the Y2 direction with respect to the origin (0)); the detection range L of the detection magnet 23 therefore can span, for example, only forward (in the Y1 direction) from the origin (0). Also, when the detection magnet 23 is too far forward (too far in the Y1 direction) from the magnetic sensor 21, the magnetic sensor 21 has to detect a weaker magnetic field H2, which makes sensitive detection difficult.

According to the examples of detection outputs shown in FIG. 6A and FIG. 6B, the detection output (i) of the first magnetic sensor 21 and the detection output (ii) of the second magnetic sensor 22 are the same value when the detection magnet 23 is located at the origin (0). When the detection magnet 23 moves forward (in the Y1 direction) from the origin (0), the sign of the difference between the detection outputs (i) and (ii) is negative, and, when the detection magnet 23 moves backward (in the Y2 direction) from the origin (0), the sign of the difference between the detection outputs (i) and (ii) is positive. The relative position identifying block 32 can therefore easily identify the position of the detection magnet 23. Consequently, in the detection part 20 shown in FIG. 1 and FIG. 5, the position of either the first magnetic sensor 21 or the second magnetic sensor 22 in the radial direction (the R1-R2 direction), or the distance between the first magnetic sensor 21 and the second magnetic sensor 22 in the front-rear direction (the Y1-Y2 direction), may be adjusted such that, when the detection magnet 23 is located at the origin (0), the detection output of the first magnetic sensor 21 and the detection output of the second magnetic sensor 22 have the same value, that is, the difference between the two detection outputs is zero. Alternatively, in the detection circuit 30 shown in FIG. 9, it is also possible to introduce a delay circuit in the detection output path of the first magnetic sensor 21 or in the detection output path of the second magnetic sensor 22, and make the detection output of the first magnetic sensor 21 and the detection output of the second magnetic sensor 22 match each other at the origin (0).

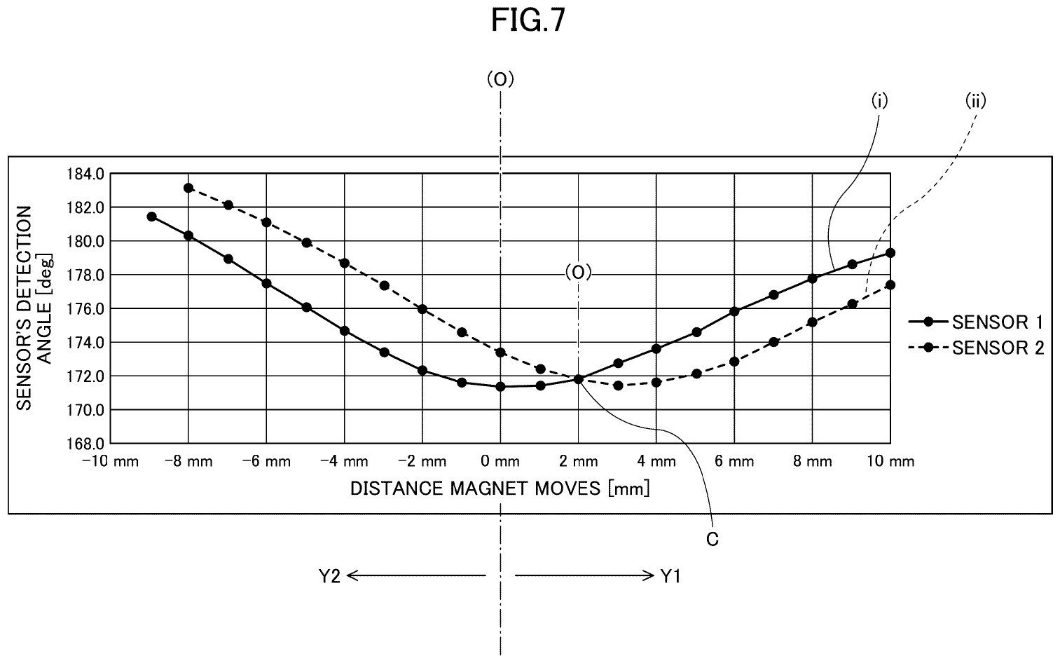

Note that the detection output of the first magnetic sensor 21 and the detection output of the second magnetic sensor 22 do not necessarily have to match at the origin (0). According to the examples of detection outputs shown in FIG. 7, when the distance between the first magnetic sensor 21 and the second magnetic sensor 22 in the front-rear direction (the Y1-Y2 direction) is long and the detection magnet 23 is located at the origin (0), the detection output of the first magnetic sensor 21 and the detection output of the second magnetic sensor 22 do not match each other. Still, in this case, the resultant value of the subtraction “the detection output from the second magnetic sensor 22”−“the detection output from the first magnetic sensor 21” as of when the detection magnet 23 is located at the origin (0) is stored as a fixed reference value, so that, when the resultant value of the subtraction “the detection output from the second magnetic sensor 22”−“the detection output from the first magnetic sensor 21” is smaller than the reference value, it is possible to determine that the detection magnet 23 is located in front of the origin (0) (in the Y1 direction with respect to the origin (0)), and, when the resultant value of the above subtraction is larger than the reference value, it is possible to determine that the detection magnet 23 is located behind the origin (0) (in the Y2 direction with respect to the origin (0)).

Alternatively, the reference value can be initialized to zero. By so doing, if the sign of the resultant value of the subtraction “the detection output from the second magnetic sensor 22”−“the detection output from the first magnetic sensor 21” is negative, it is possible to determine that the detection magnet 23 is located in front of the origin (0) (in the Y1 direction with respect to the origin (0)). Likewise, if the sign of the resultant value of the above subtraction is positive, it is possible to determine that the detection magnet 23 is located behind the origin (0) (in the Y2 direction with respect to the origin (0)). Furthermore, according to the changes of detection outputs shown in FIG. 7, regardless of whether the first magnetic sensor 21 and the detection magnet 23 are in the same position in the radial direction (the R1-R2 direction), the intersection point C where the difference between the detection output (i) of the first magnetic sensor 21 and the detection output (ii) of the second magnetic sensor 22 is zero can be set at the origin (0).

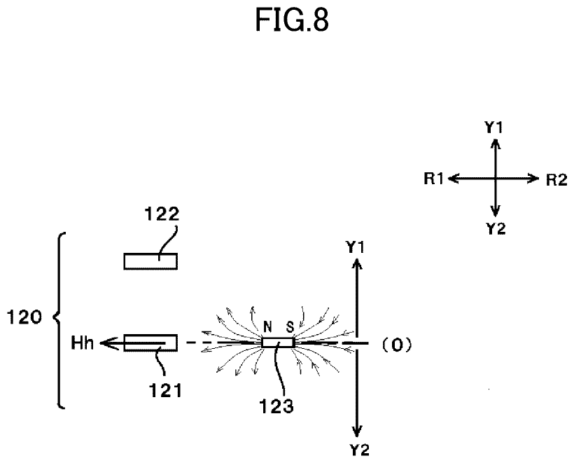

FIG. 8 shows a detection part 120 according to a modification. The detection part 120 is provided with a first magnetic sensor 121, a second magnetic sensor 122, and a detection magnet 123. The first magnetic sensor 121 and the second magnetic sensor 122 are fixed to the drive-and-support part, and the detection magnet 123 is attached to the bobbin 6 of the vibrating part. The detection magnet 123 is magnetized in the radial direction (the R1-R2 direction), and the first magnetic sensor 121 and the second magnetic sensor 122 detect changes in the intensity of the inward (R1) magnetic field Hh based on the magnetic flux leaking from the detection magnet 123. In other words, the first magnetic sensor 121 and the second magnetic sensor 122 detect only the magnetic field Hh produced from the detection magnet 123. The first magnetic sensor 121 and the second magnetic sensor 122 use Hall elements or AMR elements with radial detection directivities (detection directivities in the R1-R2 direction).

In the detection part 120 shown in FIG. 8, again, it is possible to determine whether the detection magnet 123 is located in front of the origin (0) (in the Y1 direction with respect to the origin (0)) or behind the origin (0) (in the Y2 direction with respect to the origin (0)) by calculating the difference between the detection output of the first magnetic sensor 121 and the detection output of the second magnetic sensor 122.

Because the detection part 120 shown in FIG. 8 does not detect the leakage of magnetic flux from the fixed magnet 11, it is also possible to employ a structure in which: the detection magnet 123 is provided in the drive-and-support part; the first magnetic sensor 121 and the second magnetic sensor 122 are attached, for example, to the bobbin 6 of the vibrating part; the detection magnet 123 is fixed; and the first magnetic sensor 121 and the second magnetic sensor 122 vibrate back and forth together with the vibrating part.

What is claimed is:

1. A speaker comprising:
a drive-and-support part having a frame;
a vibrating part supported by the frame such that the vibrating part is able to vibrate;
a magnetic drive part configured to make the vibrating part vibrate;
a detection magnet provided in one of the drive-and-support part or the vibrating part;
a first magnetic sensor and a second magnetic sensor provided in the other one of the drive-and-support part or the vibrating part, and configured to detect a magnetic field produced by the detection magnet; and
a detection circuit configured to determine a difference between a first detection output of the first magnetic sensor and a second detection output of the second magnetic sensor,
wherein the first and second magnetic sensors are spaced apart from each other in a direction in which the vibrating part vibrates.

2. The speaker according to claim 1,
wherein the first and second magnetic sensors are fixed to the drive-and-support part, and
wherein the detection magnet is provided in the vibrating part.

3. The speaker according to claim 1,
wherein the first and second magnetic sensors are provided in the drive-and-support part,
wherein the detection magnet is provided in the vibrating part,
wherein, for each of the first and second magnetic sensors, an orientation of a first magnetic field imparted from a fixed magnet that is fixed to the drive-and-support part, and an orientation of a second magnetic field imparted from the detection magnet, intersect with each other, and
wherein each of the first and second magnetic sensors detects changes in intensities of the first and second magnetic fields.

4. The speaker according to claim 3, wherein each of the first and second magnetic sensors detects a change in an orientation of a composite vector obtained by combining the first and second magnetic fields from the two directions.

5. The speaker according to claim 3,
wherein a magnetic circuit part that constitutes the magnetic drive part is provided in the drive-and-support part,
wherein a voice coil is provided in the vibrating part,
wherein the fixed magnet is a part of the magnetic circuit part, and
wherein the first magnetic field from the fixed magnet travels across the voice coil.

6. The speaker according to claim 1,
wherein the vibrating part is in a neutral position when the magnetic drive part is not at work, and
wherein, when the vibrating part is in the neutral position, the detection circuit determines that the difference between the first detection output of the first magnetic sensor and the second detection output of the second magnetic sensor is zero.

7. The speaker according to claim 6, wherein, when the vibrating part is in the neutral position, the detection magnet and one of the first magnetic sensor or the second magnetic sensor are positioned side by side in a direction that is perpendicular to the direction in which the vibrating part vibrates.
